(19) United States
(12) Patent Application Publication
(10) Pub. No.: US 2025/0257759 A1
(43) Pub. Date: Aug. 14, 2025

(54) SYSTEMS FOR A DRIVE AXLE

(71) Applicant: DANA ITALIA S.R.L., Arco (IT)

(72) Inventors: Pradip JASUD, Pune (IN); Sushil PATIL, Pune (IN); Shailesh DALVI, Pune (IN)

(21) Appl. No.: 18/441,320

(22) Filed: Feb. 14, 2024

(51) Int. Cl. F16C 3/02; F16H 57/04

(52) U.S. Cl. CPC F16C 3/02; F16H 57/0423; F16H 57/0454; F16H 57/0483

(57) ABSTRACT

Methods and systems for a drive axle. The drive axle includes a central portion including a differential assembly, the differential assembly including axle shaft side gears with a plurality of fins in contact with lubricant of an axle housing, and an arm portion including axle shafts, the arm portion including an inner inclined surface to guide oil toward the central portion and a plurality of holes distributed axially.

### TECHNICAL FIELD The present disclosure relates generally to a drive axle.

### BACKGROUND AND SUMMARY

A drive axle in a vehicle or other type of machinery may include relatively high lubricant demands for desired operation. Drive axles used in heavy machinery and/or industrial equipment may be relatively large and demand a large volume of lubricant. However, large volumes of lubricant may lead to churning losses and additional costs associated with manufacture and maintenance. Thus, a drive axle assembly with a design configured to decrease a lubricant volume while still meeting lubricant demands may be desired.

In one example, the issues described above may be at least partially addressed by an axle housing including a central portion including a differential assembly, the differential assembly including axle shaft side gears with radially extending fins contact lubricant of the axle housing, and an arm portion including axle shafts, the arm portion including an inner inclined surface to guide oil toward the central portion and a plurality of holes distributed axially.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings, in which:

FIG. 1 shows a drive axle according to an embodiment of the present disclosure;

FIG. 2 shows a prior art example of a drive axle;

FIG. 3A shows an embodiment of a lubricant partition of the drive axle according to an embodiment of the present disclosure;

FIG. 3B shows an isometric view of an axle housing of the drive axle according to an embodiment of the present disclosure;

FIG. 3C shows an isometric section view of the lubricant partition according to an embodiment of the present disclosure;

FIG. 4A shows a front and a rear view of the axle housing interior core area according to an embodiment of the present disclosure;

FIG. 4B shows a top view of the axle housing interior core area according to an embodiment of the present disclosure;

FIG. 5A shows a case differential cap according to an embodiment of the present disclosure;

FIG. 5B shows a fin angle according to an embodiment of the present disclosure;

FIG. 6 shows the case differential carrier including a lubricant gallery according to an embodiment of the present disclosure;

FIG. 7 shows an example lubricant flow from the case differential cap to a differential ring gear according to an embodiment of the present disclosure;

FIG. 8 shows an example lubricant fill level of the axle housing according to an embodiment of the present disclosure;

FIG. 9 shows an example lubricant fill level of the prior art axle housing; and

FIG. 10 shows a fully assembled view of the drive axle according to an embodiment of the present disclosure.

### DETAILED DESCRIPTION

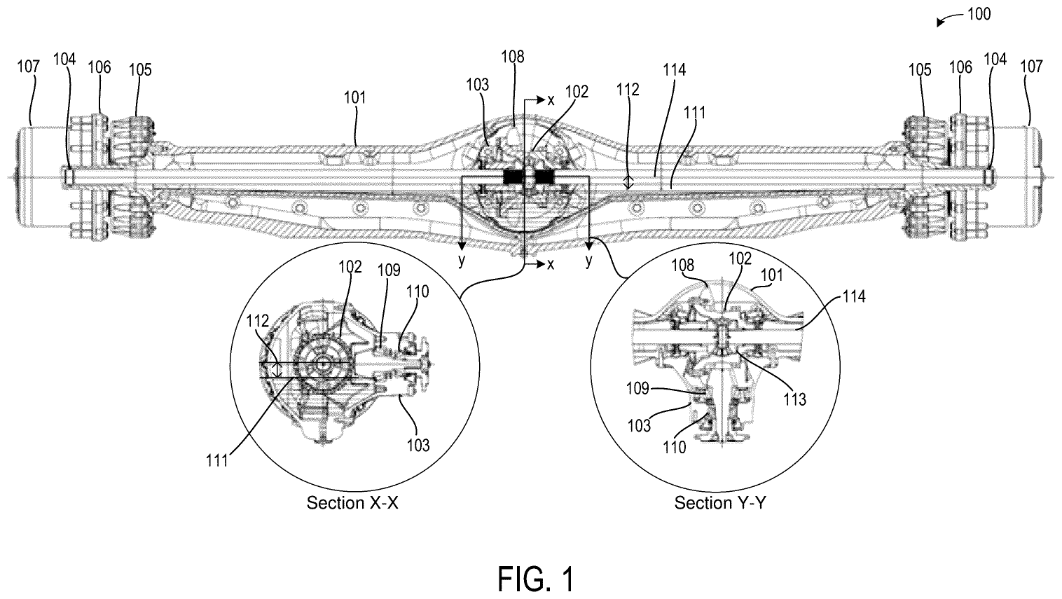

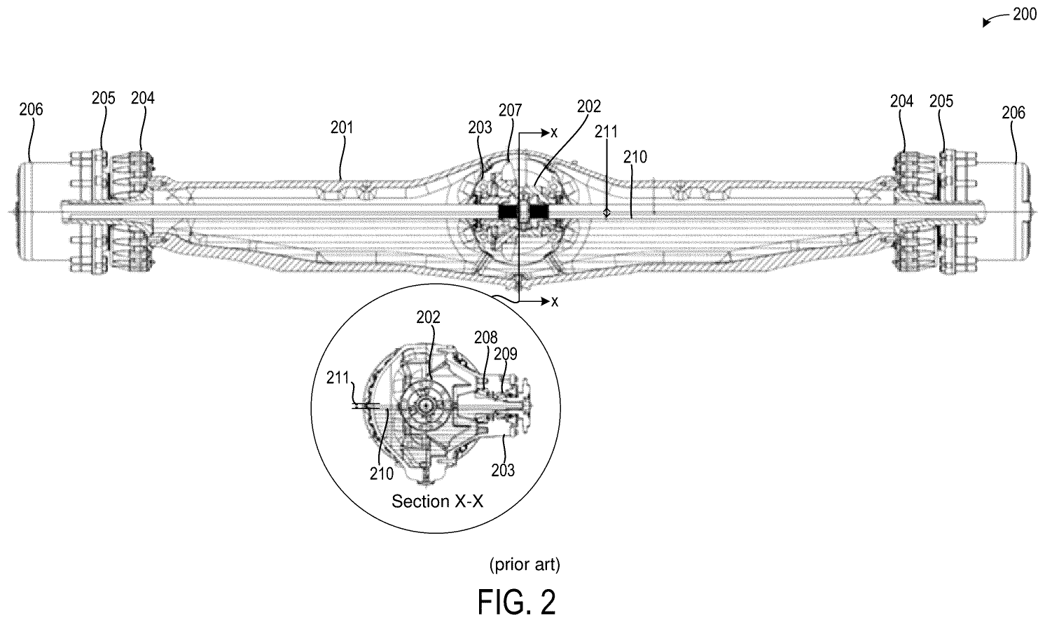

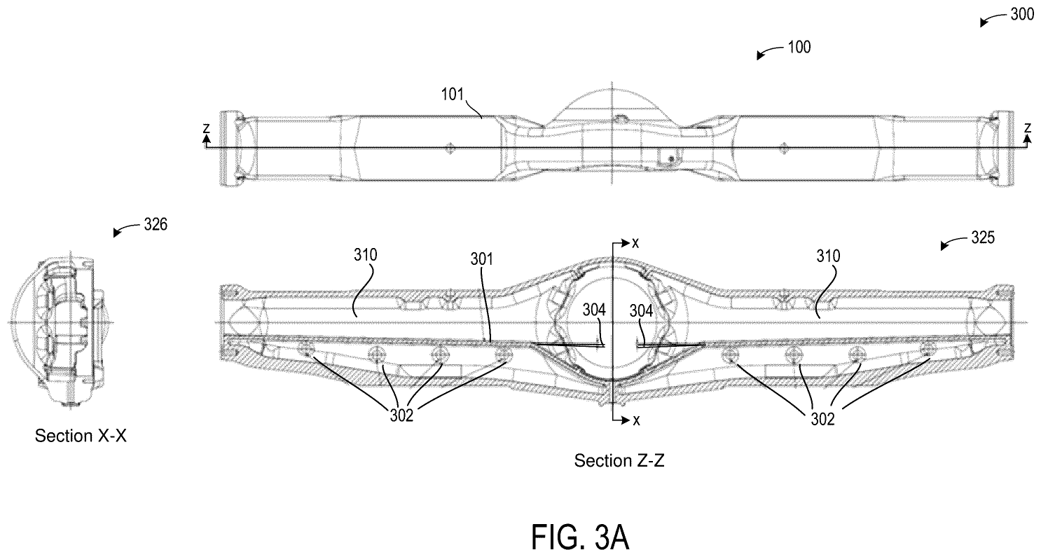

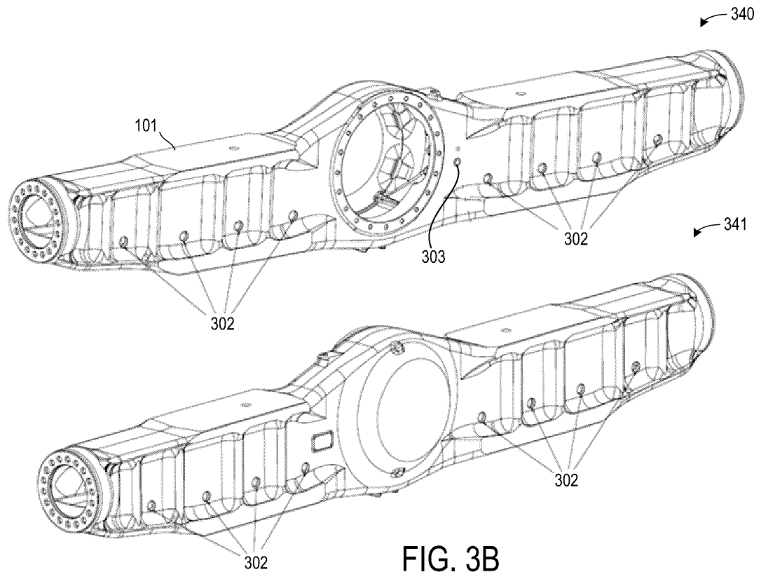

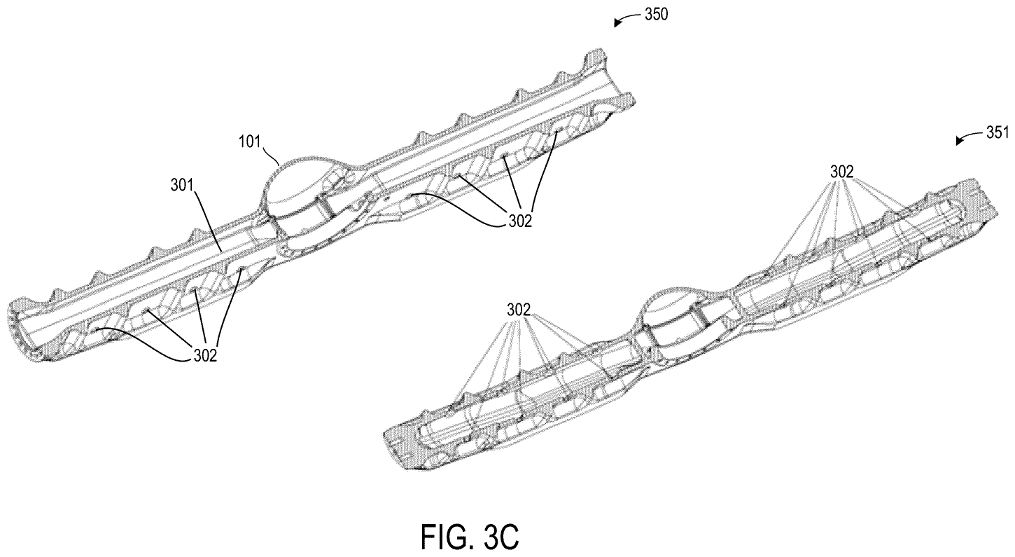

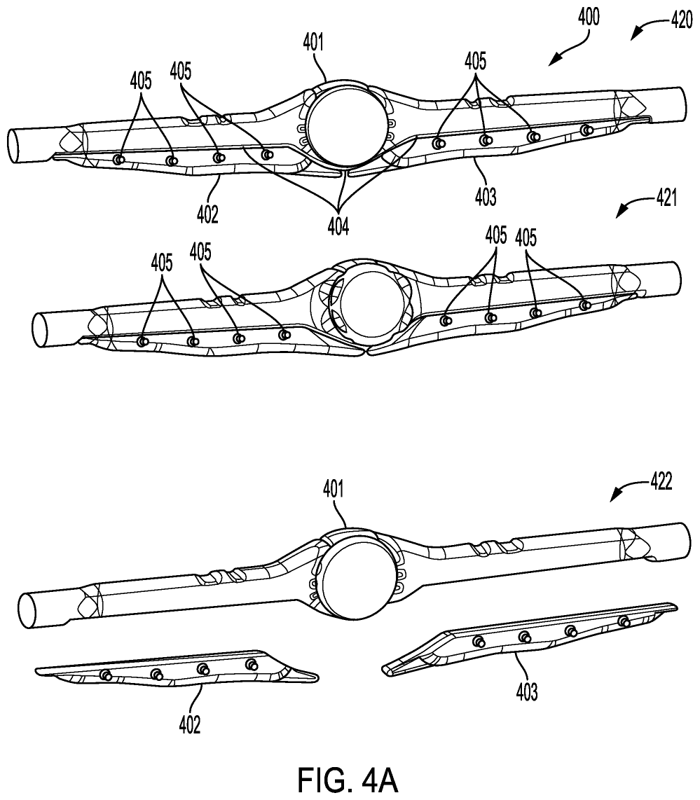

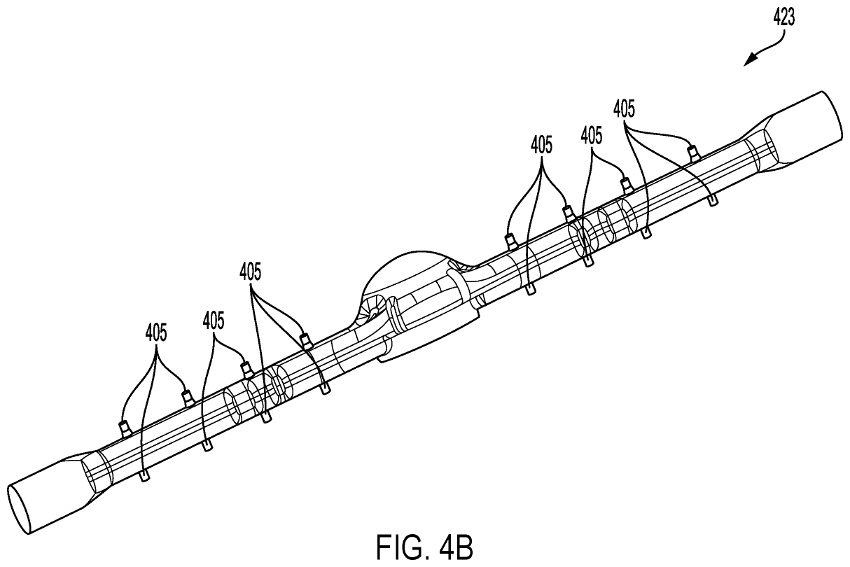

The disclosure provides support for systems including a drive axle. FIG. 1 shows a drive axle according to an embodiment of the present disclosure. FIG. 2 shows a prior art example of a drive axle. FIG. 3A shows an embodiment of a lubricant partition of the drive axle according to an embodiment of the present disclosure. FIG. 3B shows an isometric view of an axle housing of the drive axle according to an embodiment of the present disclosure. FIG. 3C shows an isometric section view of the lubricant partition according to an embodiment of the present disclosure. FIG. 4A shows a front and a rear view of the axle housing interior core area according to an embodiment of the present disclosure. FIG. 4B shows a top view of the axle housing interior core area according to an embodiment of the present disclosure;

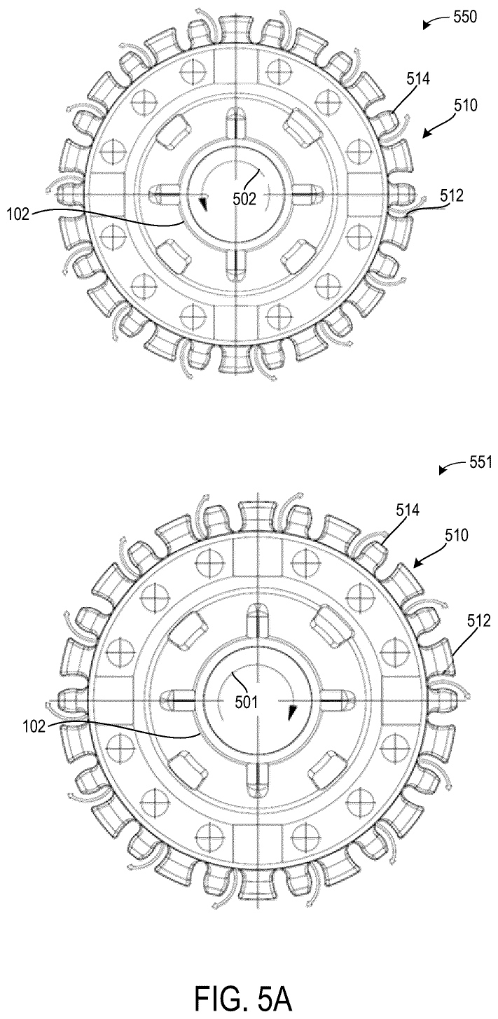

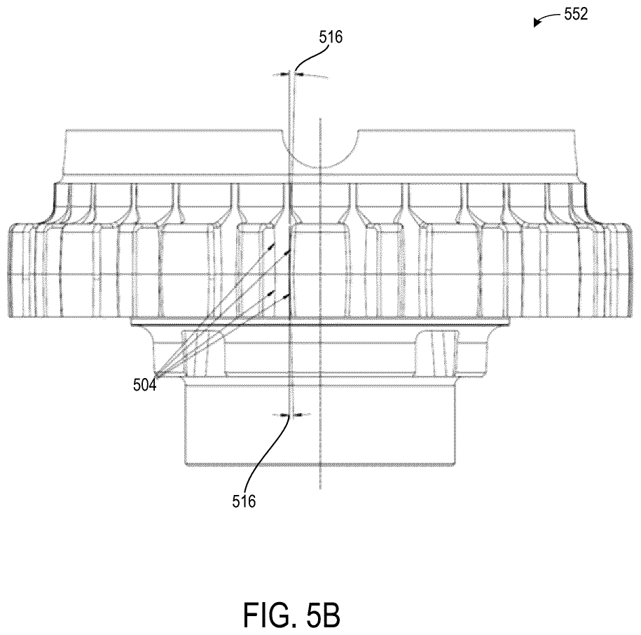

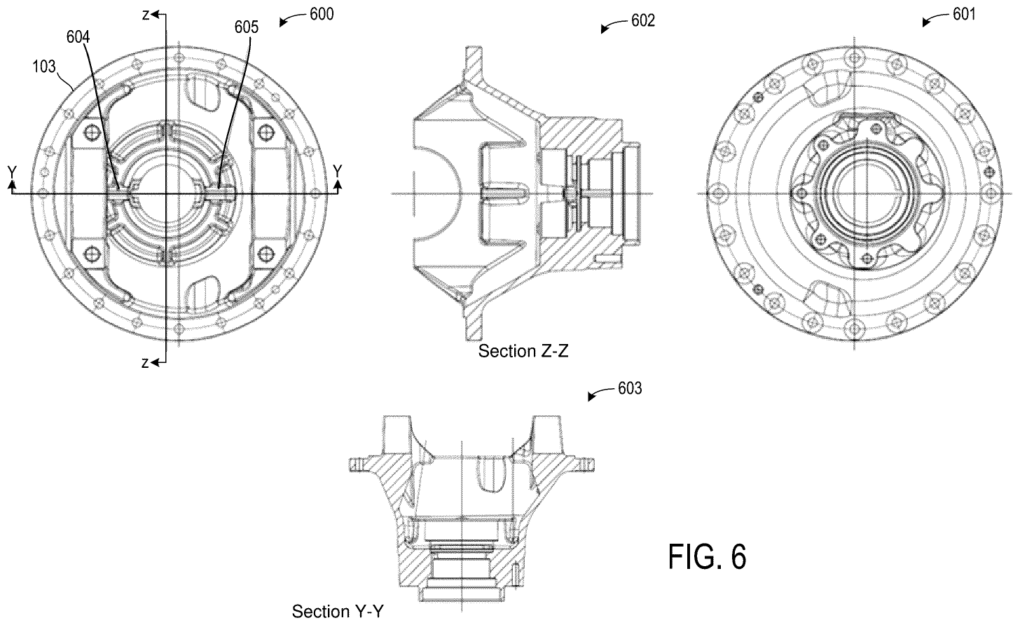

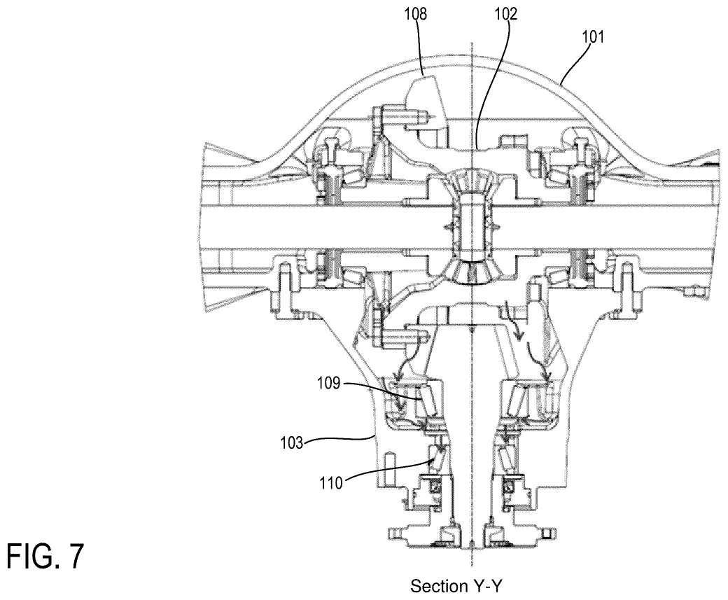

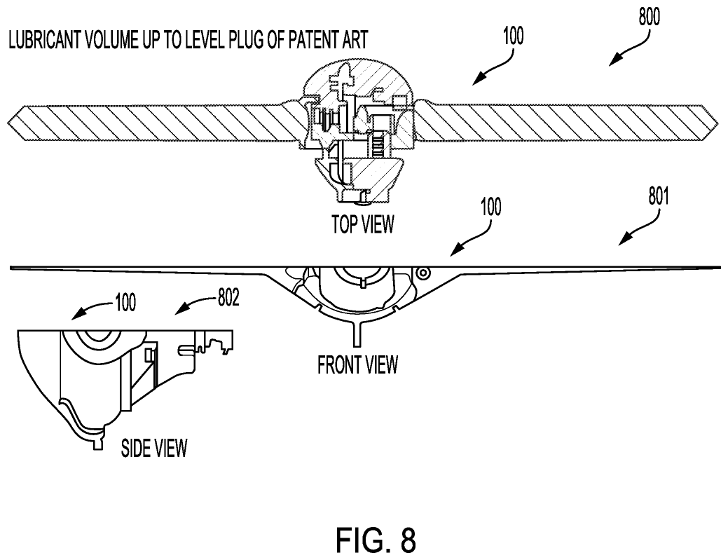

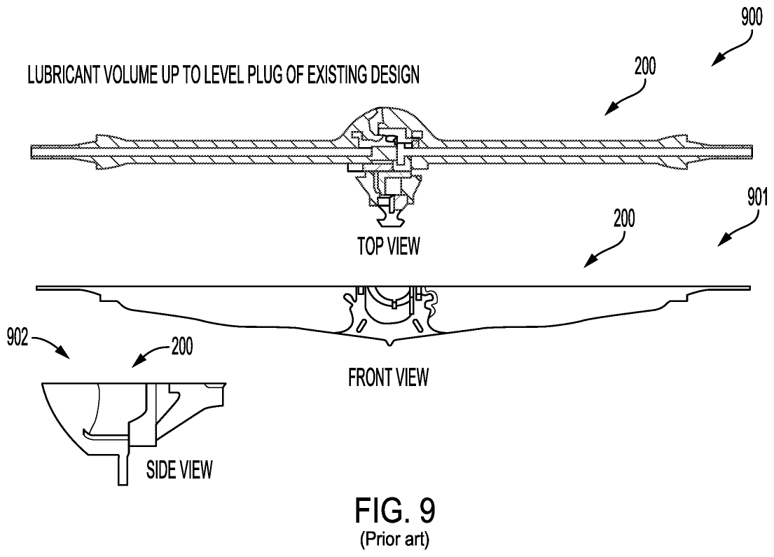

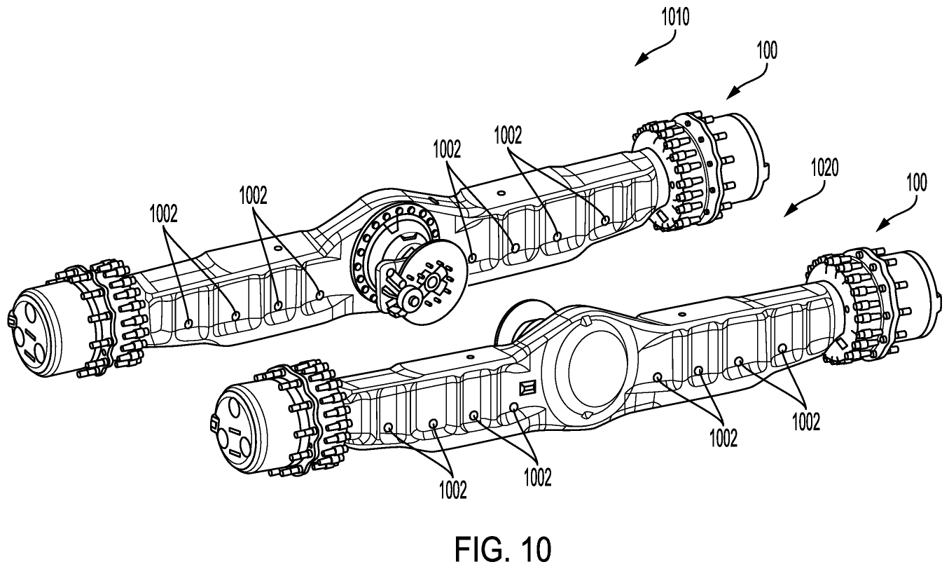

FIG. 5A shows a case differential cap according to an embodiment of the present disclosure. FIG. 5B shows a fin angle according to an embodiment of the present disclosure. FIG. 6 shows the case differential carrier including a lubricant gallery according to an embodiment of the present disclosure. FIG. 7 shows an example lubricant flow from the case differential cap to a differential ring gear according to an embodiment of the present disclosure. FIG. 8 shows an example lubricant fill level of the axle housing according to an embodiment of the present disclosure. FIG. 9 shows an example lubricant fill level of the prior art axle housing. FIG. 10 shows a fully assembled view of the drive axle according to an embodiment of the present disclosure.

Turning now to FIG. 1, it shows a drive axle 100 with higher mechanical efficiency. The drive axle 100 comprises an axle housing 101 with lubricant partition. The drive axle 100 further includes a case differential cap half 102 including lubricant circulators, such as fins. The drive axle 100 further includes a differential carrier 103 with lubricant galleries. There are two galleries in differential carrier 103, first the case differential cap half side gallery 604 and second differential ring gear side gallery 605 (shown in FIG. 6). The lubricant partition may include a plurality of oil seals 104 may be included to maintain a lubricant quantity and to separate lubricant in the central portion of the drive axle 100 from the wheel end. The drive axle 100 may further include a plurality of side gears 113, axle shafts 114, a plurality of brakes 105 coupled to a plurality of hubs 106. The plurality of hubs 106 may be coupled to a plurality of planet carries 107.

The drive axle 100 may include a differential ring gear 108 in the case differential. Cross-sections X-X and Y-Y show a differential head bearing 109, differential tail bearing 110, and lubricant level 111 from axle shaft center.

A mechanical efficiency of the drive axle 100 is increased due to less lubricant used in the drive axle 100 relative to prior art drive axle 200 of FIG. 2. This drive axle concept can be used for off-highway applications where the axle housing size is large. In one example, the lubricant level 111 may be higher than a prior art lubricant level 210 of FIG. 2.

FIG. 2 shows a prior art example of a drive axle 200. The drive axle 200 includes an axle housing 201 without a lubricant partition. As such, lubricant in the central portion of the drive axle 200 may not be separated from wheel ends of the drive axle 200. The drive axle 200 may include a case differential cap 202 without lubricant circulators, a differential carrier 203 without additional oil galleries, two brakes 204, two wheel hubs 205, and two planet carriers 206. The drive axle 200 may further include a differential ring gear 207, a differential head bearing 208, a differential tail bearing 209, and a lubricant level 210 from an axle shaft center. The drive axle 200 may be powered by a transmission or a motor through differential. The prior art drive axle 200 requires more lubricant than the drive axle 100 because there is no partition separating lubricant in the central portion of the drive axle 200 from the wheel ends. This results in a greater amount of lubricant and a relatively higher lubricant level 210 relative to the lubricant level 111. A distance 211 illustrates a distance between the axle shaft center and the lubricant level 210. As illustrated, the distance 211 is less than a distance 112, which shows a distance between the axle shaft center of the drive axle 100 and the lubricant level 111. In one example, the distance 211 is five times less than the distance 112. The increased amount of lubricant in the drive axle 200 may increase a drive axle overall weight as well as resistance to rotating parts. This may result in increased churning losses and heat. The mechanical efficiency of prior art drive axle 200 is lower as compared to the drive axle 100 of the present disclosure.

In one example, the lubricant level is defined from an axle shaft center line, which is shown by distances 112 of FIG. 1 and 211 of FIG. 2. As the distances increase, the lubricant quantity decreases.

Turning now to FIG. 3A, it shows a detailed view 300 of the axle housing 101. Cross-section 325 taken along the cutting plane Z-Z illustrates a lubricant partition 301 on which an angle 304 is maintained to keep lubricant in center section. In one example, the angle 304 is sloped toward the case differential and away from the wheel ends. The angle 304 may be less than 5°, less than 3°, and/or less than 2°. In one example, the angle 304 is equal to 1.5°.

An axle housing arm lubricant partition casting wall 301, arranged between a top and a bottom wall and connecting casting side walls 310, may function as a rib to provide increased strength to the drive axle 100. The axle housing arm lubricant partition casting wall 301 may help to reduce weight of a rest area of sections due to increased strength of the axle housing 101. Below the lubricant partition 301, a plurality of core holes 302 are arranged. The plurality of core holes 302 may be used to support the core of the drive axle 100 during manufacturing. The plurality of core holes 302 may be further used to flush the core sand. The plurality of core holes 302 may be plugged with core plugs when the drive axle 100 is arranged in a vehicle. The plurality of core holes 302 are provided to support the sand core in the casting mold. Supports may arrange the large size core rigidly and more accurately inside a mold during manufacture. The plurality of core holes 302 of axle housing may reduce the final weight of casting by reducing wall thickness variation and the manufacturing cost as well. The plurality of core holes 302 may also remove the gases evolved within the core of such a large housing. The venting process may mitigate the casting defects such as blowhole, shrinkage, etc. Ultimately this will increase strength of large axle housing casting by reducing defects, which may increase the strength and longevity of the axle housing 101. Cross-section 326 shows an additional view of the case differential along cutting plane X-X.

Turning now to FIG. 3B, it shows a front isometric view 340 and a rear isometric view 341 of the axle housing 101. The plurality of core holes 302 are inline from front to rear side of the axle housing. The front isometric view 340 shows a level plug hole 303 which may maintain a lubricant volume up to the lubricant level 111 of FIG. 1.

Turning now to FIG. 3C, it shows an isometric sectional view of axle housing 101. FIG. 3C includes an isometric sectional view through an axle shaft center 350 and an isometric sectional view through axle core holes 351. The isometric sectional view through axle shaft center 350 shows the lubricant partition (301) geometry and the isometric sectional view through axle core holes 351 shows eight of the plurality of core holes 302.

Turning now to FIG. 4A, it shows a front view 420 and a rear view 421 of a core 400 used for manufacturing of the axle housing 101. The core 400 includes of a top core 401, a first bottom core 402, and a second bottom core 403, which is shown in view 422. A lubricant partition gap 404 is maintained between the top core 401, the first bottom core 402, and the second bottom core 403 to create the lubricant partition (e.g., lubricant partition 301 of FIG. 3A). Core supports 405 may support the cores and create core holes in axle housing 101. View 422 shows the top core 401, the first bottom core 402, and the second bottom core 403 separated from one another.

Turning now to FIG. 4B, it shows a top view 423 of a core used for manufacturing of axle housing 101. There are eight core supports 405 which are inline from front to rear side of the axle housing core, similar to the plurality of core holes.

Turning now to FIG. 5A, it shows views 550 and 551 of the differential cap half 102 with lubricant circulators. The case differential includes of a plurality of fins 510, which circulates the lubricant in clockwise direction 501 or in a counterclockwise direction 502. The plurality of fins 510 may include a plurality of first fins 512 and a plurality of second fins 514. The plurality of first fins 512 may include a square shape with concave surfaces. The plurality of second fins 514 may include a thimble shape with convex walls. In one example, the plurality of first fins 512 may alternate with the plurality of second fins 514 such that neighboring of the plurality of first fins 512 are separated by one of the plurality of second fins 514. A number of the plurality of first fins 512 may be equal to a number of the plurality of second fins 514. In one example, the number of first fins is equal to 14 and the number of second fins is equal to 14. Each of the plurality of fins 510 includes an angle 516 as shown in FIG. 5B. The angle 516 may spread lubricant in either direction (e.g., clockwise or counterclockwise), which may circulate and direct lubricant towards the differential carrier 103, as shown in FIG. 7.

In embodiment 552 of FIG. 5B, the angle 516 of surfaces 504 of the plurality of first fins 512 and the plurality of second fins 514 is identical. The angle 516 may be less than 5°, less than 3°, and/or less than 2°. In one example, the angle 516 is equal to exactly 1.5°. which is provided to spread lubricant in either direction.

Turning now to FIG. 6, it shows the differential carrier 103 with the lubricant galleries. The differential carrier includes lubricant galleries including a differential cap half side gallery 604 and the differential ring gear side gallery 605. Rotation of the differential cap half 102 and the differential ring gear 108 splashes lubricant towards gallery 604 & 605, which further transfers to the differential head bearing 109 and the differential tail bearing 110, as shown in FIG. 7. In this way the center section may be lubricated with less lubricant compared to the prior art drive axle 200.

FIG. 6 shows a rear view 600 of the differential carrier 103, a front view 601 of the differential carrier, a cross-sectional view 602 taken along a Z-Z cutting plane, and a cross-sectional view 603 taken along a Y-Y cutting plane.

FIG. 7 shows the lubricant flowing, via arrows from the differential cap half 102 and the differential ring gear 108 to the differential head bearing 109 and the differential tail bearing 110, via lubricant galleries shaped in the differential carrier.

The differential carrier has lubricant galleries, the differential cap half side gallery 604 and differential ring gear side gallery 605. These both galleries are opened on head bearing outer diameter & continue to tail outer bearing diameter (shown in FIG. 7). FIG. 8 shows the lubricant total lubricant quantity used for the drive axle 100. FIG. 8 includes a top view 800, a front view 801, and a side view 802, each taken along a cutting plane parallel to the lubricant level 111 of FIG. 1. The lubricant level may be maintained by filling lubricant up to level plug hole 303 (shown in FIG. 3B). Lubricant quantity may be approximately 12 liters, which is 76% less than the lubricant quantity used in the prior art drive axle 200. The approximate weight of 12 liters of lubricant is 11 Kg, which is 77.5% less than prior art drive axle 200.

FIG. 9 shows the lubricant total lubricant quantity required for the prior art drive axle 200. FIG. 9 shows a top view 900, a front view 901, and a side view 902 of the drive axle 200 cut along the lubricant level 210. Lubricant quantity will be approximately 51 liters which is 76% higher than the drive axle 100. The approximate weight of 51 liters of lubricant is 49 Kg which is 77.5% higher than drive axle 100.

FIG. 10 shows the drive axle 100 including a plurality of core plugs 1002. The plurality of core plugs 1002 are inserted into the plurality of core holes 302 on a front side of the drive axle 100, as shown in view 1010, and on a rear side of the drive axle 100, as shown in view 1020.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

The disclosure provides support for a drive axle including a central portion comprising a differential assembly, the differential assembly comprising axle shaft side gears with a plurality of fins in contact with lubricant of an axle housing, and an arm portion comprising axle shafts, the arm portion comprising an inner inclined surface to guide oil toward the central portion and a plurality of holes distributed axially. A first example of the drive axle further includes where the arm portion comprises a seal between the central portion and a wheel portion. A second example of the drive axle, optionally including the first example, further includes where the seal is configured to block lubricant from flowing from the central portion to the wheel portion. A third example of the drive axle, optionally including one or more of the previous examples, further includes where the inner inclined surface is sloped toward the central portion. A fourth example of the drive axle, optionally including one or more of the previous examples, further includes where the inner inclined surface is configured to return lubricant toward the central portion and away from a wheel portion arranged at an end of the arm portion. A fifth example of the drive axle, optionally including one or more of the previous examples, further includes where the plurality of fins comprises a plurality of first fins and a plurality of second fins different than the plurality of first fins. A sixth example of the drive axle, optionally including one or more of the previous examples, further includes where a second fin of the plurality of second fins is arranged between neighboring first fins of the plurality of first fins. A seventh example of the drive axle, optionally including one or more of the previous examples, further includes where surfaces of the plurality of fins are angled.

The disclosure provides additional support for a drive axle assembly including a case differential comprising a plurality of fins along a central portion of a drive axle and a plurality of seals arranged between the central portion of the drive axle and wheel ends arranged at opposite extreme ends of the drive axle. A first example of the drive axle assembly further includes where the plurality of fins comprises angled surfaces configured to direct lubricant in a clockwise direction or a counterclockwise direction. A second example of the drive axle assembly, optionally including the first example, further includes where an arm portion of the drive axle extends from the central portion to the wheel ends, the arm portion sloped toward the central portion. A third example of the drive axle assembly, optionally including one or more of the previous examples, further includes where the plurality of fins comprises a plurality of first fins and a plurality of second fins different than the plurality of first fins. A fourth example of the drive axle assembly, optionally including one or more of the previous examples, further includes where the plurality of fins extends radially outward from the axle shaft side gears. A fifth example of the drive axle assembly, optionally including one or more of the previous examples, further includes lubricant galleries extending from a differential cap half and a differential ring gear to a differential head bearing and a differential tail bearing. A sixth example of the drive axle assembly, optionally including one or more of the previous examples, further includes where seals of the plurality of seals are arranged at the wheel ends.

The disclosure provides further support for a system including a drive axle assembly comprising an axle extending between wheel ends and a differential cap centrally arranged between the wheel ends, wherein a plurality of lubricant galleries extend from a differential cap half and a differential ring gear to a differential head bearing and a differential tail bearing. A first example of the system further includes where a plurality of fins is arranged on a differential side gear, wherein the plurality of fins comprises convex and concave surfaces configured to direct lubricant in clockwise and counterclockwise directions. A second example of the system, optionally including a first example, further includes where a plurality of seals is arranged between the differential cap and the wheel ends. A third example of the system, optionally including one or more of the previous examples, further includes where the axle comprises sloped surfaces that decline from the wheel ends toward the differential cap. A fourth example of the system, optionally including one or more of the previous examples, further includes a plurality of core holes arranged in the axles plugged with a plurality of core plugs.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

FIGS. 1-10 show example configurations with relative positioning of various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 1-10 are shown approximately to scale. However, other dimensions may be used if desired.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A drive axle, comprising:
a central portion comprising a differential assembly, the differential assembly comprising axle shaft side gears with a plurality of fins in contact with lubricant of an axle housing, and an arm portion comprising axle shafts, the arm portion comprising an inner inclined surface to guide oil toward the central portion and a plurality of holes distributed axially.

2. The drive axle of claim 1, wherein the arm portion comprises a seal between the central portion and a wheel portion.

3. The drive axle of claim 2, wherein the seal is configured to block lubricant from flowing from the central portion to the wheel portion.

4. The drive axle of claim 1, wherein the inner inclined surface is sloped toward the central portion.

5. The drive axle of claim 4, wherein the inner inclined surface is configured to return lubricant toward the central portion and away from a wheel portion arranged at an end of the arm portion.

6. The drive axle of claim 1, wherein the plurality of fins comprises a plurality of first fins and a plurality of second fins different than the plurality of first fins.

7. The drive axle of claim 6, wherein a second fin of the plurality of second fins is arranged between neighboring first fins of the plurality of first fins.

8. The drive axle of claim 1, wherein surfaces of the plurality of fins are angled.

9. A drive axle assembly, comprising:
a case differential comprising a plurality of fins along a central portion of a drive axle; and
a plurality of seals arranged between the central portion of the drive axle and wheel ends arranged at opposite extreme ends of the drive axle.

10. The drive axle assembly of claim 9, wherein the plurality of fins comprises angled surfaces configured to direct lubricant in a clockwise direction or a counterclockwise direction.

11. The drive axle assembly of claim 9, wherein an arm portion of the drive axle extends from the central portion to the wheel ends, the arm portion sloped toward the central portion.

12. The drive axle assembly of claim 9, wherein the plurality of fins comprises a plurality of first fins and a plurality of second fins different than the plurality of first fins.

13. The drive axle assembly of claim 9, wherein the plurality of fins extends radially outward from the axle shaft side gears.

14. The drive axle assembly of claim 9, further comprising lubricant galleries extending from a differential cap half and a differential ring gear to a differential head bearing and a differential tail bearing.

15. The drive axle assembly of claim 9, wherein seals of the plurality of seals are arranged at the wheel ends.

16. A system, comprising:
a drive axle assembly comprising an axle extending between wheel ends; and
a differential cap centrally arranged between the wheel ends, wherein a plurality of lubricant galleries extend from a differential cap half and a differential ring gear to a differential head bearing and a differential tail bearing.

17. The system of claim 16, wherein a plurality of fins is arranged on a differential side gear, wherein the plurality of fins comprises convex and concave surfaces configured to direct lubricant in clockwise and counterclockwise directions.

18. The system of claim 16, wherein a plurality of seals is arranged between the differential cap and the wheel ends.

19. The system of claim 16, wherein the axle comprises sloped surfaces that decline from the wheel ends toward the differential cap.

20. The system of claim 16, further comprising a plurality of core holes arranged in the axles plugged with a plurality of core plugs.
